(19) United States
(12) Patent Application Publication
(10) Pub. No.: US 2009/0187524 A1
(43) Pub. Date: Jul. 23, 2009

(54) COLLABORATIVE REASONING IN A COGNITIVE TOOL

(75) Inventors: Daniel M. Gruen, Newton, MA (US); Susanne C. Hupfer, Lexington, MA (US); Stephen E. Levy, Honolulu, HI (US); John F. Patterson, Carlisle, MA (US); Steven I. Ross, South Hamilton, MA (US); Nishanth R. Sastry, Cambridge, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/017,026

(22) Filed: Jan. 19, 2008

(51) Int. Cl. G06N 5/02

(52) U.S. Cl. 706/50

(57) ABSTRACT

Embodiments of the present invention address deficiencies of the art in respect to group cognition and provide a method, system and computer program product for collaborative reasoning. In an embodiment of the invention, a method for collaborative reasoning in a cognitive tool can be provided. The method can include arranging shared entities in a collaborative reasoning shared knowledge base into different models for different end users in different investigations, creating claims for the shared entities in the different models across the different investigations, subscribing the different end users for notification of changes to the claims and shared entities, and providing notice to the subscribed different end users responsive to detecting a change in a claim in one of the different models.

### STATEMENT AS TO FEDERALLY SPONSORED RESEARCH

This invention was made with Government support under Contract No. H98230-07-C-0383 awarded by the U.S. Department of Defense. The Government may have certain rights in this invention.

### BACKGROUND OF THE INVENTION

1. Field of the Invention

The present invention relates to the field of shared cognition and more particularly to the field of model sharing in a distributed cognitive reasoning environment.

2. Description of the Related Art

Collaborative computing provides a means for users to pool their strengths and experiences to achieve a common goal. For example, a common goal may be an educational objective, the completion of a software development project or even creation and use of a system to manage human resources. The establishment of a collaborative computing environment typically involves the creation or definition of a community. The community provides the framework under which the collaborative computing objective is achieved.

A collaborative computing community is defined by (1) a particular context, i.e. the objective of the community, (2) membership, i.e., the participants in the community, and (3) a set of roles for the community members. Roles are names given to the people in the community which dictate access to the community's resources and tools as well as define the behavior of the community members. Community creators or administrators may desire that roles have specific access and policy attributes for the different business components, i.e. tools, resources, etc. within the community.

Cognitive reasoning and group cognition tools differ from collaborative computing environments. In this regard, while collaborative computing environments support informal collaborative reasoning, collaborative computing environments remain fundamentally just communication tools and cannot understand or interpret the content being communicated. Thus, collaborative computing environments are not capable of supporting the reasoning process taking place beyond facilitating the communication. In cognitive reasoning, on the other hand, teams manifest distributed cognition through a variety of representations such as concept maps and through accessing knowledge ingredients of the group partners.

For example, conventional group cognition tools enable groups to share claims derived from concept maps in a shared repository known as a “knowledge soup”. Thereafter, users can selectively publish claims to the knowledge soup, and can examine, question, and criticize the claims of others in order to arrive at a shared understanding of a subject area represented by the knowledge soup. Changes in the underlying ontology used for the claims, however, and also changes in the claims themselves, can invalidate the analysis performed by each member of the group resulting in distracting efforts to synchronize changes in the knowledge soup throughout the group.

### BRIEF SUMMARY OF THE INVENTION

Embodiments of the present invention address deficiencies of the art in respect to group cognition and provide a novel and non-obvious method, system and computer program product for collaborative reasoning. In an embodiment of the invention, a method for collaborative reasoning in a cognitive tool can be provided. The method can include arranging shared entities in a collaborative reasoning shared knowledge base into different models for different end users in different investigations, creating claims for the shared entities in the different models across the different investigations, subscribing the different end users for notification of changes to the claims and shared entities, and providing notice to the subscribed different end users responsive to detecting a change in a claim in one of the different models.

In one aspect of the embodiment, providing notice to the subscribed different end users responsive to detecting a change in a claim in one of the different models also can include providing notice to the subscribed different end users responsive to detecting a change in a shared entity in one of the different models. In another aspect of the embodiment, providing notice to the subscribed different end users responsive to detecting a change in a claim in one of the different models, further can include providing notice to the subscribed different end users responsive to detecting a change in an underlying ontology for the shared entities. Optionally, the change can be merged into another of the different models. Finally, as another option, an indication of an end user responsible for the detected change can be provided, and presence awareness can be indicated for the end user to others of the end users receiving the notice.

In another embodiment of the invention, a cognitive tool data processing system can be configured for collaborative reasoning. The system can include a host server configured for communicative coupling to different clients used respectively by different end users and a shared knowledge base of shared entities and claims for the shared entities coupled to the host server. The system also can include collaborative reasoning logic executing in the host server. The logic can include program code enabled to arrange selected ones of the shared entities into different models for the different end users for different investigations and to create claims for the shared entities in the different models, to publish model snapshots of the different models, to subscribe the different end users for notification of changes to the claims and shared entities, and to provide notice to the subscribed different end users responsive to detecting a change in any of a shared entity and a claim in one of the different models.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a shared knowledge base utilized for collaborative reasoning in a cognitive tool;

FIG. 2 is a pictorial illustration of a cognitive tool user interface supporting collaborative reasoning;

FIG. 3 is a cognitive tool data processing system configured for collaborative reasoning; and,

FIG. 4 is a flow chart illustrating a process for collaborative reasoning in a cognitive tool.

### DETAILED DESCRIPTION OF THE INVENTION

Embodiments of the present invention provide a method, system and computer program product for collaborative reasoning in a cognitive tool. In accordance with an embodiment of the present invention, entities belonging to one or more classes in an ontology can be shared within a shared knowledge base amongst different model snapshots for different collaborators using a cognitive tool. Within each of the model snapshots, as a property of an entity or a claim of an entity changes in one of the model snapshots, a notification can be provided to collaborators utilizing others of the model snapshots once the model snapshots have been published for viewing by the collaborators. In consequence, the change for the entity can be merged or expressly rejected by the collaborators on a snapshot by snapshot basis in order to propagate the collaborative reasoning resulting from the change for the entity amongst the model snapshots.

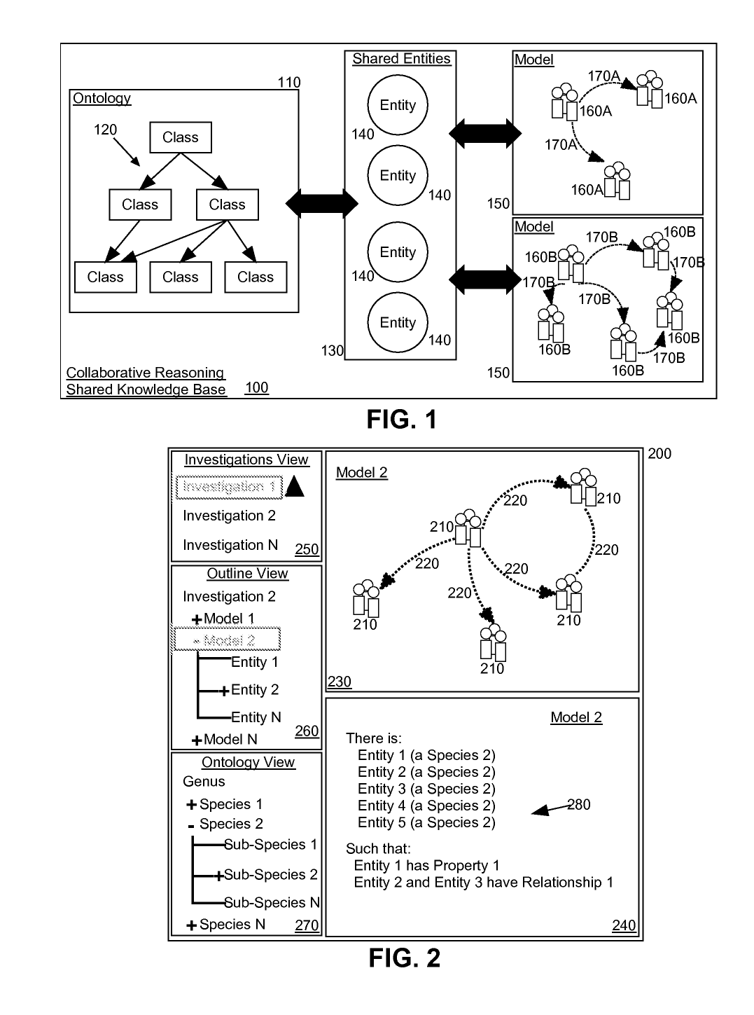

In further illustration, FIG. 1 is a pictorial illustration of a shared knowledge base utilized for collaborative reasoning in a cognitive tool. As shown in FIG. 1, an ontology 110 can be defined within a collaborative reasoning shared knowledge base 100. The ontology 110 can account for a hierarchy of classes 120 to which one or more entities 140 can belong. The entities 140 can be placed in a pool of shared entities 130 and utilized in multiple different model instances 150. In this regard, each of the model instances 150 can be a snapshot of a model in which different entities 160A, 160B are related to one another through one or more relating claims 170A, 170B.

Each model instance 150 as a snapshot of a model can be published and used during the course of which the entities 160A, 160B, the claims 170A, 170B or both can change in the model instance 150. To the extent that a change implicates an entity 140 in the pool 130, either directly or by way of a changed claim, notice can be provided to all other model instances 150 utilizing the entity 140. Thereafter, the difference in the affected one of the model instances 150 can be identified and either merged into or rejected by the affected one of the model instances 150. In this way, the reasoning reflected in the changed entity 140 can be shared amongst all collaborators irrespective of the model instance 150 in which the changed entity 140 is utilized.

The process described herein can be supported by a cognitive tool user interface in which model instances can be displayed and manipulated and further through which changes in the models for shared entities can be indicated and merged or rejected as the case may be. In further illustration, FIG. 2 is a pictorial illustration of a cognitive tool user interface supporting collaborative reasoning. The user interface 200 can include a model view 230 of a model instance including both entities 210 and claims 220 between the entities 210. In this regard, entities 210 can include by way of example persons, places, resources and organizations, while claims 220 can include a defined relationship between entities 210 or a property or characteristic of corresponding ones of the entities 210. As it will be recognized by the skilled artisan, the entities 210 and claims in the model instance can be modified directly through the model view 230.

An outline view 260 further can be provided in the user interface 200. The outline view 260 can provide a view to a hierarchy of different models in an investigation. In this regard, an investigation can include multiple different model instances, each including one or more entities and corresponding claims. Selecting a model in the hierarchy of the outline view 260 can result in a corresponding model instance being rendered in the model view 230. Similarly, an ontology view 270 can be provided in the user interface 200. The ontology view 270 can provide a hierarchy of entity membership from genus through one or more layers of sub-species. In particular, each entity 210 in a model can be characterized according to one or more nodes in the hierarchy.

Yet further, a progressive summary view 240 can be provided in the user interface in connection with a selected model in the outline view 260 and the model view 230. The progressive summary view 240 can list each entity 210 present in the model instance and a position in the hierarchy shown in the ontology view 270 for each entity 210. The progressive summary view 240 also can set forth the claims 220 of the model instance. Finally, an investigations view 250 even yet further can be provided in the user interface 200. The investigations view 250 can provide a listing of investigations of models to which a user is a member and also can indicate subscriptions to model instances for the investigations including model instances utilizing shared entities and also an underlying ontology. In this way, when a change occurs in a shared entity, a claim involving a shared entity, or an ontological node relied upon in a model instance, a notification can be provided and an opportunity can be presented to merge the change into the model instance.

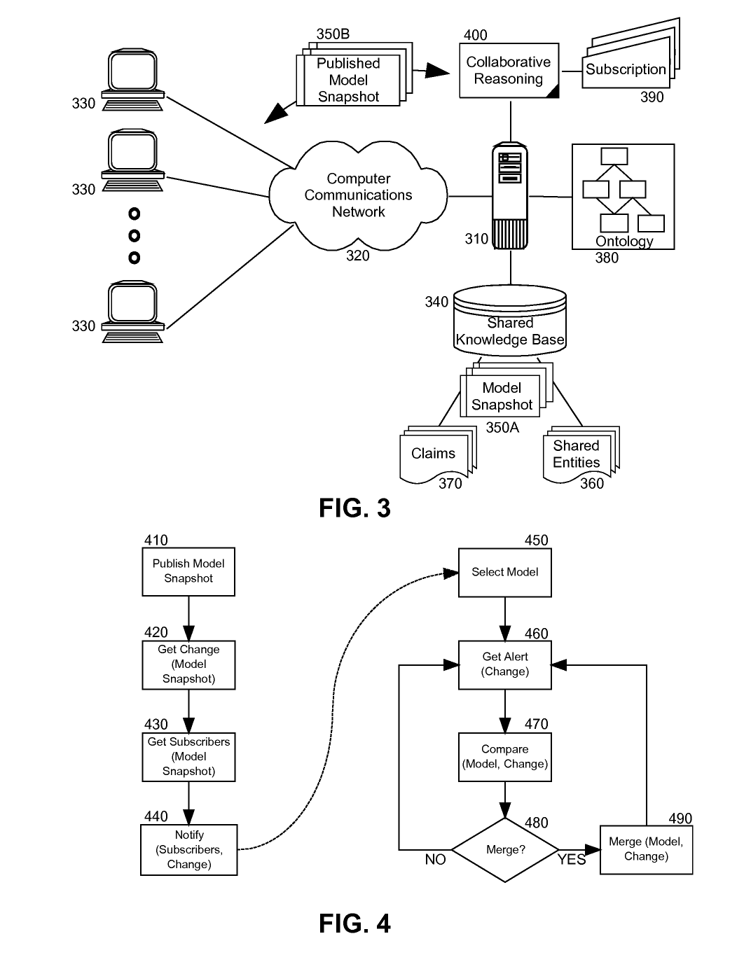

The user interface 200 can be provided in connection with backend logic in a cognitive tool data processing system. In illustration, FIG. 3 pictorially shows a cognitive tool data processing system configured for collaborative reasoning. The system can include a host server 310 configured for communicative coupling to multiple different clients 330 over computer communications network 320. The host server 310 can be coupled to a shared knowledge base 340 of both shared entities 360 and claims 370 for the shared entities 360. Further, the host server 310 can be coupled to an ontology 380 providing a hierarchy of nodes characterizing the shared entities 360.

Collaborative reasoning logic 400 can execute in the host server 310. The collaborative reasoning logic 400 can include program code enabled to compose models 350A from different shared entities 360 and claims 370 there between. The program code further can be enabled to publish model instances 350B of the models 350A once frozen for use in an investigation by an end user. Yet further, the program code can be enabled to manage subscriptions 390 to different model instances 350B such that subscribers can be provided with notice for changes to the entities 360, claims 370 or even classes in the ontology 380 used in a subscribed one of the model instances 350B.

In yet further illustration of the operation of the collaborative reasoning logic 400, FIG. 4 is a flow chart illustrating a process for collaborative reasoning in a cognitive tool. The process can begin in block 410 with the publication of a model snapshot. The change can include, for instance, a change in a claim for a shared entity reflected in the model snapshot, or a change in the shared entity itself in the model snapshot. Alternatively, the change can include a change to a class in an ontology relied upon in classifying the entities in the model snapshot according to a hierarchy of classifications represented by the ontology.

In any event, in block 420 the change can be retrieved in connection with the model snapshot. In block 430, members of an investigation incorporating elements of the model snapshot including the shared entities, claims and ontology can be determined and in block 440, a notification can be provided to the subscribers of the change. Optionally, a subscriber being notified of a change can be provided with information about the source of the change as well as presence awareness permitting real time communications to be initiated with the end user responsible for the change. In this way, those incorporating shared entities, claims and a shared ontology in different model snapshots and indeed in different investigations can collaboratively build upon the reasoning of each other through the notification and merging of changes in the underlying shared entities, claims and classes in the ontology.

In block 450, an end user can select a model for use in modeling an investigation or a portion of an investigation and in block 460, notice can be received of a change in an underlying shared entity, claim or class in an ontology. In block 470, the change can be compared to the selected model to identify differences. Thereafter, in decision block 480, it can be determined whether to merge the change into the selected model, or whether to ignore the change. If the decision is to merge the change, in block 490 the change can be merged into the model.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for collaborative reasoning in a cognitive tool, the method comprising:
arranging shared entities in a collaborative reasoning shared knowledge base into different models for different end users in different investigations;
creating claims for the shared entities in the different models across the different investigations;
subscribing the different end users for notification of changes to the claims and shared entities; and,
providing notice to the subscribed different end users responsive to detecting a change in a claim in one of the different models.

2. The method of claim 1, further comprising merging the detected change into another of the different models.

3. The method of claim 1, further comprising:
providing an indication of an end user responsible for the detected change; and,
indicating presence awareness for the end user to others of the end users receiving the notice.

4. The method of claim 1, wherein providing notice to the subscribed different end users responsive to detecting a change in a claim in one of the different models, further comprises providing notice to the subscribed different end users responsive to detecting a change in a shared entity in one of the different models.

5. The method of claim 1, wherein providing notice to the subscribed different end users responsive to detecting a change in a claim in one of the different models, further comprises providing notice to the subscribed different end users responsive to detecting a change in an underlying ontology for the shared entities.

6. A cognitive tool data processing system configured for collaborative reasoning, the system comprising:
a host server configured for communicative coupling to different clients used respectively by different end users;
a shared knowledge base of shared entities and claims for the shared entities coupled to the host server; and,
collaborative reasoning logic executing in the host server, the logic comprising program code enabled to arrange selected ones of the shared entities into different models for the different end users for different investigations and to create claims for the shared entities in the different models, to publish model snapshots of the different models, to subscribe the different end users for notification of changes to the claims and shared entities, and to provide notice to the subscribed different end users responsive to detecting a change in any of a shared entity and a claim in one of the different models.

7. A computer program product comprising a computer usable medium embodying computer usable program code for collaborative reasoning in a cognitive tool, the computer program product comprising:
computer usable program code for arranging shared entities in a collaborative reasoning shared knowledge base into different models for different end users in different investigations;
computer usable program code for creating claims for the shared entities in the different models across the different investigations;
computer usable program code for subscribing the different end users for notification of changes to the claims and shared entities; and,
computer usable program code for providing notice to the subscribed different end users responsive to detecting a change in a claim in one of the different models.

8. The computer program product of claim 7, further comprising computer usable program code for merging the detected change into another of the different models.

9. The computer program product of claim 7, further comprising:
computer usable program code for providing an indication of an end user responsible for the detected change; and,
computer usable program code for indicating presence awareness for the end user to others of the end users receiving the notice.

10. The computer program product of claim 7, wherein the computer usable program code for providing notice to the subscribed different end users responsive to detecting a change in a claim in one of the different models, further comprises computer usable program code for providing notice to the subscribed different end users responsive to detecting a change in a shared entity in one of the different models.

11. The computer program product of claim 7, wherein the computer usable program code for providing notice to the subscribed different end users responsive to detecting a change in a claim in one of the different models, further comprises computer usable program code for providing notice to the subscribed different end users responsive to detecting a change in an underlying ontology for the shared entities.
